(19) United States
(12) Patent Application Publication
(10) Pub. No.: US 2026/0209008 A1
(43) Pub. Date: Jul. 23, 2026

(54) SAFE LIFTING LINK

(71) Applicant: WOODSTOCK PERCUSSION PTY LTD, Paddington, New South Wales (AU)

(72) Inventor: Rodney MACKAY SIM, Paddington, New South Wales (AU)

(73) Assignee: WOODSTOCK PERCUSSION PTY LTD, Paddington, New South Wales (AU)

(21) Appl. No.: 19/138,723

(22) PCT Filed: Nov. 17, 2023
(86) PCT No.: PCT/AU2023/051169

§ 371 Date: Jun. 13, 2025

(30) Foreign Application Priority Data
Dec. 13, 2022 (AU) 2022903812

(51) Int. Cl. B66C 1/66

(52) U.S. Cl. CPC B66C 1/666

(57) ABSTRACT

A releasable lifting link for lifting concrete elements (11) having an embedded anchor (6) with an aperture (16) in the anchor's head, the link comprising a hollow toroidal body (4) having a central hole (3) for engagement with a shackle (2) and a transverse slot (9) for receiving the head, and an arcuate latch (14) being rotatably mounted within the body about a toroid centre of rotation (18), the latch being rotatable between an open position in which a free end (50A) of the latch is retracted to open the slot and a latching position in which the latch free end extends through and beyond the aperture (18). The latch has a circular extent approaching 360°, or the latch is fabricated in two pivoted parts, or the centre of gravity of the latch is moved towards the toroid centre of rotation. A lifting method is also disclosed.

### FIELD OF THE INVENTION

The present invention relates to a releasable lifting link for connection to a load. In particular, the invention relates to a lifting link for connection to an anchoring element embedded in a concrete panel to enable it to be safely lifted, turned and manoeuvred whilst freely suspended without unintended disconnection from the anchoring element.

### BACKGROUND ART

The construction of buildings is facilitated by using walling elements in the form of thin concrete panels. Panels are often manufactured in factories after which the panels must be transported to the job site for erection.

These concrete panel wall elements are commonly cast in the horizontal position, with one face adjacent to the casting mould. When the concrete has cured sufficiently, the panel is lifted by inserts embedded in one of the long edges and rotated from the horizontal to the vertical position by tilting about the edge opposed to the edge in which the lifting inserts are located. The panel is stored and transported to the job site in the vertical or near vertical position with the panel supported on a long edge.

The panels are often lifted edgewise from the transport vehicle and rotated in mid-air by using a combination of lifting inserts embedded in the long and short edges and finally placed into the building structure using inserts located in the upper short edge. In this way the long dimension of the panel may be designed to span between one or more storeys of a building.

Preferably the panels are placed into the final position using the inserts located in the upper edge which ensures that the panel hangs vertically simplifying the panel erection and its attachment to the building structure.

Releasable lifting links for connection between embedded lifting anchors and the hoisting chains are known. One known type of link is that disclosed in International Patent No. WO/2008/154673 and is used to connect to the head of an anchor having a generally planar body which is embedded in concrete. This anchor incorporates a through aperture to which a latching device incorporated within the releasable link attaches. The anchor is cast within a surrounding recess such that the head of the anchor lies below the surface of the concrete thereby protecting it from damage.

The lifting link has the form of a hollow ring, or a toroidal body, and a pivotable shackle element for connection to the hoisting system passing through the internal transverse hole of the toroidal body. The lower part of the toroidal body has a transverse slot which enables it to envelope the head of the anchor. An arcuate latching device is fitted to rotate within the hollow arcuate cavity of the toroidal body.

The latching device has a semi-circular configuration and incorporates a radial lever arm which extends from one end, and which facilitates the rotation of the latching device. The upper periphery of the toroidal body is removed to form a U-shaped slot through which the radial arm passes during rotation.

Connection of the lifting link to the anchor is achieved by rotation of the latching device such that it lies within the hollow body in a position where it does not obstruct the transverse slot in the toroidal body. The toroidal body then envelopes the anchor head such that the axis of the hollow chamber within the toroidal body is aligned with the axis of the aperture in the anchor head. The arcuate latching ring is then rotated within the hollow chamber of the toroidal body so that it passes through the aperture in the anchor head, thereby connecting the anchor to the lifting link.

WO 82/01541 (US 4367892A) discloses a lifting link adapted for the releasable connection to anchors cast in concrete panels used for tilt-up construction of wall panels. In order to prevent disconnection during the lifting operation, this link must be connected in one particular orientation only, such that the rotation of the latching ring is restrained by contact between the lever arm and the shackle element. In practice it is impossible to guarantee that the link will be connected in this particular orientation and so the device is potentially unsafe. Personal injury and property damage have resulted when links of this type have been connected in this unsafe orientation and subsequently disconnected from the anchoring device whilst suspended by the hoisting system.

### Genesis of the Invention

The genesis of the present invention is a desire to provide an improved releasable lifting link which is simple to use, able to be connected safely in any orientation and which does not rely upon complex locking mechanisms which could be prone to damage or failure.

### SUMMARY OF THE INVENTION

In accordance with a first aspect of the present invention there is disclosed a releasable lifting link for lifting concrete elements having an embedded anchor with a through aperture in the anchor's head, said lifting link comprising a hollow toroidal body with an interior arcuate surface and a through aperture for engagement with a lifting shackle and a transverse slot for receiving the head of the anchor, and an arcuate latch having a centre of gravity and being rotatably mounted within the toroidal body about a toroid centre of rotation, said latch having a handle which projects beyond the body, and said latch being rotatable between an open position in which a free end of said latch is retracted to open said transverse slot and a latching position in which said latch free end extends through and beyond said aperture, wherein said latch is fabricated in two or more parts which are pivoted relative to each other.

In accordance with a second aspect of the present invention there is disclosed a releasable lifting link for lifting concrete elements having an embedded anchor with a through aperture in the anchor's head, said lifting link comprising a hollow toroidal body with an interior arcuate surface and a through aperture for engagement with a lifting shackle and a transverse slot for receiving the head of the anchor, and an arcuate latch with a centre of gravity and having a first free end and a second end which terminate the circumferential arcuate length of said latch, said arcuate latch being rotatably mounted within the toroidal body about a toroid centre of rotation, said latch having a handle which projects beyond the body, and said latch being rotatable between an open position in which the said first free end of said latch is retracted to open said transverse slot and a latching position in which said latch free end extends through and beyond said aperture, wherein the distance between the first free end and the second end is less than a diameter of said interior surface of said toroidal body.

According to another aspect of the present invention there is disclosed in a releasable lifting link for lifting concrete elements having an embedded anchor with a through aperture in the anchor's head, said lifting link comprising a hollow toroidal body with an interior arcuate surface and a through aperture for engagement with a lifting shackle and a transverse slot for receiving the head of the anchor, and an arcuate latch having a centre of gravity and being rotatably mounted within the toroidal body about a toroid centre of rotation, said latch having a handle which projects beyond the body, and said latch being rotatable between an open position in which a free end of said latch is retracted to open said transverse slot and a latching position in which said latch free end extends through and beyond said aperture, the improvement comprising modifying said latch such that with said lifting link in a lifting position, the centre of gravity of said latch is closer to said toroid centre of rotation.

In accordance with a still further aspect of the present invention there is also disclosed a method of lifting a concrete element having an embedded anchor with a through aperture in the anchor's head, using a releasable lifting link comprising a hollow toroidal body with an interior arcuate surface and a through aperture for engagement with a lifting shackle and a transverse slot for receiving the head of the anchor, and an arcuate latch having a centre of gravity, and a first free end and a second end which terminate the circumferential arcuate length of said latch, said arcuate latch being rotatably mounted within the toroidal body about a toroid centre of rotation, said latch having a handle which projects beyond the body, and said latch being rotatable between an open position in which the said first free end of said latch is retracted to open said transverse slot and a latching position in which said latch free end extends through and beyond said aperture, wherein said method comprises the step(s) of
(i) making the distance between the first free end and the second end less than a diameter of said interior surface of said toroidal body, and/or
(ii) fabricating said latch in two or more parts which are pivotable relative to each other, and/or
(iii) modifying said latch such that with said lifting link in a lifting position, the centre of gravity of said latch is closer to said toroid centre of rotation.

### BRIEF DESCRIPTION OF THE DRAWINGS

Preferred embodiments of the present invention will now be described with reference to the drawings in which:

FIG. 1 is a perspective view of a prior art lifting link and co-operating anchor,

FIG. 1A is a perspective view of a prior art lifting link and co-operating anchor embedded in the horizontal face of a concrete panel,

FIG. 1B is a perspective view of a prior art lifting link and co-operating anchor embedded in the horizontal edge of a concrete panel,

FIG. 1C is a perspective view of a prior art lifting link and co-operating anchor embedded in the vertical edge of a concrete panel,

FIG. 2A is a vertical section through the prior art lifting link of FIG. 1,

FIG. 2B is a side elevation of the prior art lifting link and shackle,

FIG. 2C is a rear elevation the prior art lifting link and shackle,

FIG. 2D is a side elevation of the prior art latching ring,

FIG. 2E is vertical section through the torus of the prior art lifting link,

FIG. 2EA is similar to FIG., 2E but showing the position of the latch prior to fitting to the link torus of then prior lifting link.

FIG. 2F is a vertical section through the prior art lifting link connected to a lifting anchor in the manner described in FIG. 1A or 1B in a horizontal top face or edge of a concrete panel,

FIG. 2G is a vertical section through the prior art lifting link connected to a lifting anchor of FIG. 1C embedded in a vertical face or edge of a concrete panel before the application of a lifting load, showing the latch in its equilibrium position with the centre of gravity vertically aligned with its centre of rotation,

FIG. 2H is similar to FIG. 2G with the latch trapped by frictional forces in its non-equilibrium position with respect to its centre of gravity,

FIG. 2I is the same as FIG. 2H showing the latch moving from the non-equilibrium position of FIG. 2H, through its equilibrium position described in

FIG. 2G and finally to the unlatched position,

FIG. 2J is a vertical elevation of prior art lifting links attached to lifting inserts located in the manner described by FIG. 1C in the end edge of a concrete element, prior to rotation of the element into the vertical position with the lifting links attached by a safe method but which is which not easy nor convenient to disconnect,

FIG. 2K is the element shown in FIG., 2J rotated into the vertical position suspended by the lifting system,

FIG. 2L is the element shown in FIG. 2K rotated into the vertical position with the lifting links unlatched,

FIGS. 2M-2O correspond to the FIGS. 2J-2L with one of the lifting links attached in an alternative configuration which is easy and convenient to disconnect but unsafe,

FIG. 3 is a side elevation of a preferred embodiment of a latch which takes the form of two parts,

FIG. 4 is a side elevation of a second embodiment of a latch which takes the form of two parts,

FIG. 5A is a vertical section of an embodiment of the toroidal ring modified to permit access for fitting the two-part latch shown in FIG. 3,

FIG. 5B is a side elevation of the toroidal ring shown in FIG. 5A,

FIG. 5C is the same as FIG. 5B, but with the latching ring of FIG. 3 installed,

FIG. 6 is a rear elevation of FIG. 5B with the stop pin installed,

FIG. 7 is the preferred embodiment of FIG. 3 but showing the latch's pivotable locking part rotated to the open position,

FIG. 8 is a side elevation of a still further embodiment of a two-part latch,

FIGS. 9 and 10 are vertical sections of the lifting link with a toroidal body of the type shown in FIG. 6 and a latch of FIG. 7 when connected to an anchor in the manner described in FIG. 1A or 1B in a horizontal top face or edge of a concrete panel, in the closed (FIG. 9) and open (FIG. 10) positions respectively,

FIGS. 11 and 12A are vertical sections of the lifting link shown in FIGS. 9 and 10 with a latch of FIG. 7 in one orientation of connection to an anchor located in the manner described by FIG. 1C in a vertical surface with the latch in the equilibrium position and with the lever arm pointing down at the commencement of lifting (FIG. 11) and after rotation by an external force and locked (FIG. 12A) positions respectively,

FIG., 12B is a vertical section of the lifting link shown in FIGS. 11 and 12A after rotation of the panel from the vertical position of FIG. 1C to the horizontal position of FIG. 1B,

FIGS. 13 and 14 are similar to FIGS. 11 and 12A but showing the lifting link of an embodiment with a latch shown in FIG. 8 connected in an orientation with the lever arm pointing up, being otherwise similar to a mirror image about the vertical surface of FIGS. 11 and 12A,

FIG. 15 is a vertical elevation of lifting links of the preferred embodiment of the invention attached to lifting inserts located in the end of a concrete element, prior to rotation of the element into the vertical position with the lifting links attached by a safe method which is also easy and convenient to disconnect,

FIG. 16 is the element shown in FIG. 15 rotated into the vertical position suspended by the lifting system,

FIG. 17 is the element shown in 16 rotated into the vertical position with the lifting links unlatched,

FIG. 18 is a side elevation of a latching ring of a still further embodiment,

FIG. 19 is a plan view of the upper part of the latching ring of FIG. 18,

FIG. 20 is a plan view of the lower part of the latching ring of FIG. 18,

FIG. 21 is a side elevation of the latching ring of FIG. 18 shown in an open configuration,

FIG. 22 is a side elevation of a latching ring of yet another embodiment,

FIG. 23 is a plan view of the upper part of the latching ring of FIG. 22,

FIG. 24 is a plan view of the lower part of the latching ring of Fig, 22, and

FIG. 25 is a side elevation of the latching ring of FIG. 22 shown in an open configuration.

### DETAILED DESCRIPTION

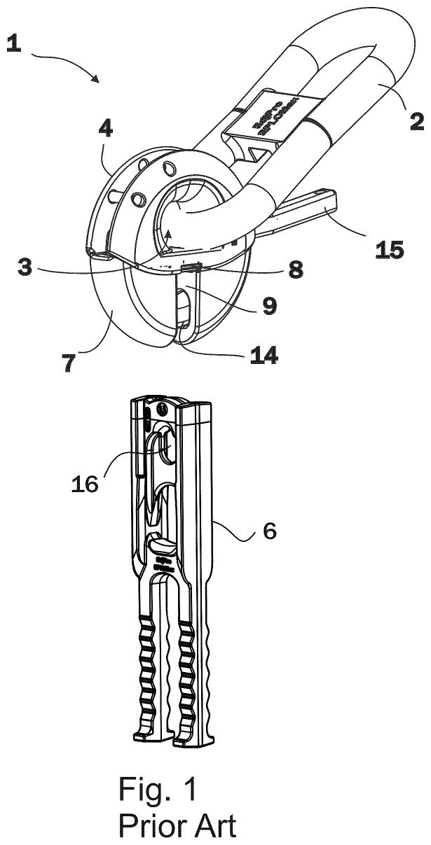

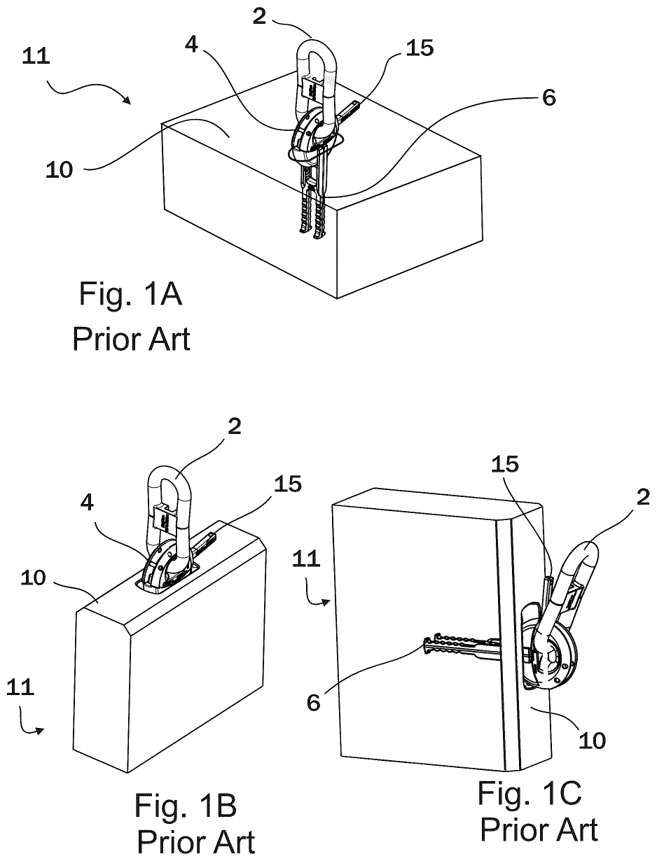

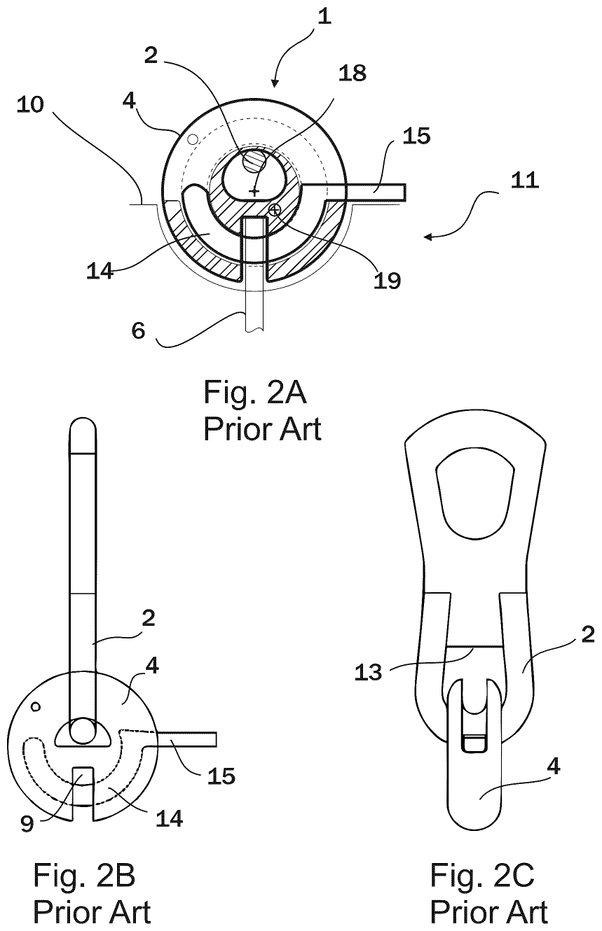

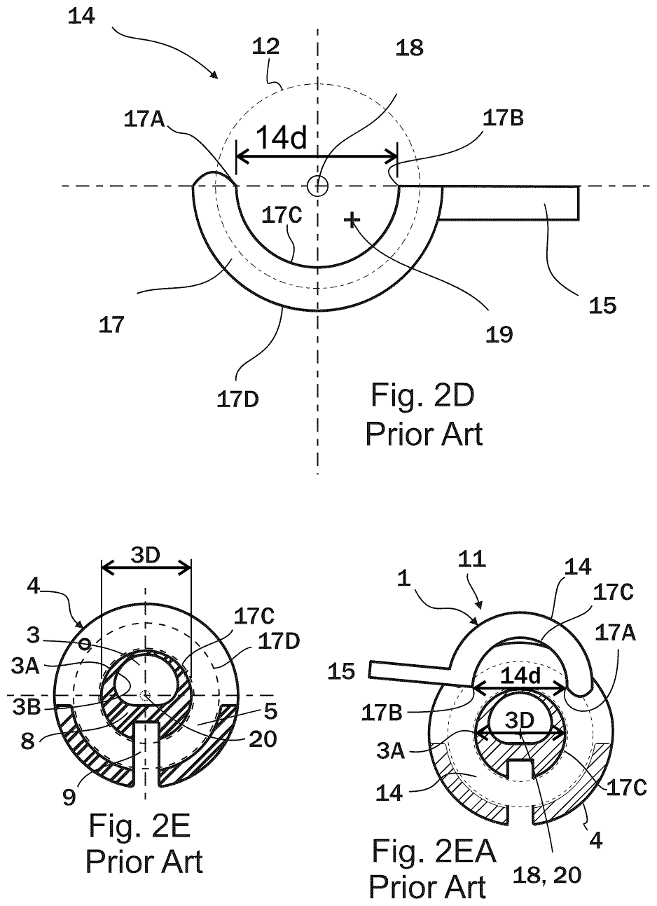

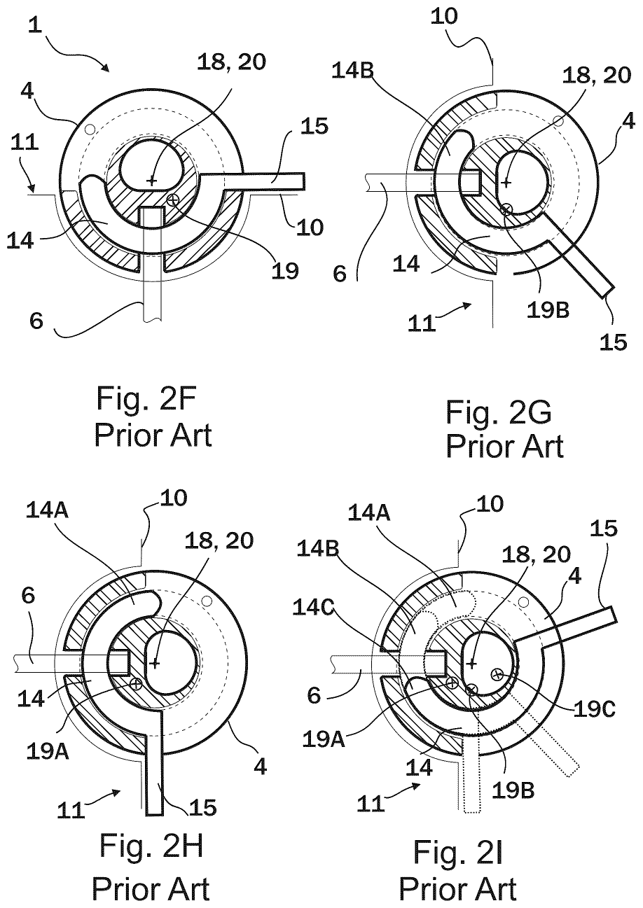

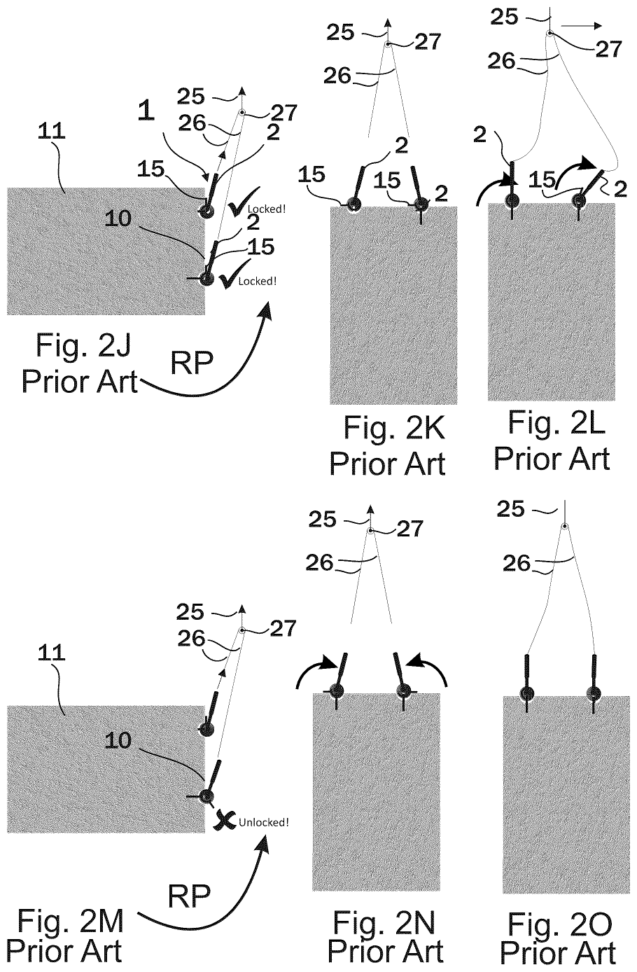

As seen in FIGS. 1-2E, the prior art lifting link 1 is attached to hoisting chains (not illustrated) with a shackle 2 or similar element which passes through a central aperture 3 in the toroidal body 4. When the known lifting link 1 is closed over the embedded anchor 6, a segment 7 of the toroidal body 4 lies below the surface 10 of the concrete element 11. The body of the torus is strengthened by a transverse bridge 8 which lies above a transverse slot 9 into which the anchor 6 is mated. The effect of this bridge 8 is to partially close the central aperture 3 which results in the central aperture 3 having a rounded generally semicircular profile with its diameter generally flush with the concrete surface 10.

Within the hollow toroidal body 4 is an arcuate latch 14 (as seen in FIG. 2D) which comprises an arcuate latching part 17 and a substantially radial lever arm 15. The arcuate latching part 17 has a centre of rotation 18, an arcuate central locus 12, a nose of a free end 17A and a nose of a second end 17B which terminate the circumferential arcuate length of the latch. There is a distance 14d between the noses 17A and 17B shown by an arrow in FIG. 2D.

FIG. 2D shows that the latch 14 has a centre of gravity 19 which is not co-incident with the centre of the arcuate locus 12. The centre of gravity 19 lies below the centre of the locus 12 in a direction toward the lever arm 15. The latching part 17 has an interior arcuate surface 17C and an exterior arcuate surface 17D. The latch 14 passes through a transverse aperture 16 in the anchor 6 of FIG. 1. The latch 14 is rotatable around the interior arcuate surface 3A of the interior cavity 5 of the toroidal body 4 which has a diameter 3D shown in FIG. 2E which is concentric with the centre 20 of the toroidal body 4. The latch 14 rotates within the arcuate cavity 5 along a path of rotation bounded by broken lines 17C and 17D where the arcuate path 17C is substantially co-incident and adjacent the interior arcuate surface 3A of the toroidal body 4. The circumferential arcuate length of the latching part 17 is substantially one-half of the length of the path of rotation defined by broken lines 17A and 17B. The radius of curvature of the latch 14 and the interior cavity 5 of body 4 are similar and have co-incident centres 18 (FIGS. 2D) and 20 (FIG. 2E). However, these centres are not co-incident with the centre of gravity 19 (FIG. 2D) of the latch 14.

FIG. 2EA shows the latch 14 immediately prior to being fitted to the toroidal body 4. The double-ended dimensional arrow 14d indicates the distance between the noses 17A, 17B of the latching part 17 of the latch 14. The double-ended dimensional arrow 3D indicates the diameter of the interior arcuate surface 3A of the cavity 5. It is self-evident that the distance 14d must be more than the diameter 3D to enable the latching part 17 to be fitted within the arcuate cavity 5 such the surface 17C of the latch 17 and the interior arcuate surface 3A of the interior cavity 5 of the body 4 are substantially congruent and the centre of gravity 18 of the latch 17 and the centre of rotation of the body 4 are co-incident.

If the distance 14d between noses 17A and 17B is less than the diameter 3D of the interior arcuate surface 3A, the latch 14 cannot be fitted into the body 4.

As seen in FIG. 2F, the prior art latch 14 has an interior circular extent of approximately 180° in order to allow the latch 14 to be coupled with the toroidal body 4 by being passed over the central hub of the toroidal body 4.

As seen in FIGS. 2A-2C, the shackle 2 passes through the central aperture 3 in the toroidal body 4 and bears against the inner surface 3B (FIG. 2E) of the body 4. Thus, the shackle 2 is free to rotate in all directions above the plane of the concrete to facilitate a lifting operation originating from any direction above the concrete plane.

These prior art lifting links 1 were conceived for the efficient connection to lifting anchors 6 placed in the horizontal top faces of concrete panels as shown in FIGS. 1A and 1B.

Provided that the surface 10 into which the lifting anchors 6 are embedded remains substantially horizontal during all lifting and handling operations, the lifting link cannot be disconnected unless the load is relaxed, and an external force is applied to the lever arm 15 of the latch 14. This force must be sufficient to overcome friction between the latch 14, body 4 and the aperture 16 of the anchor 6 so as to allow rotation of the latch 14 until it is clear of the hole 16 of the anchor 6, thereby releasing the connection between the link 1 and anchor 6. The requirement for a secondary force to be applied to the lever arm 15 only after the load has been relaxed in order to disconnect the link 1 from the anchor 6, eliminates the possibility of unintentional disconnection under load.

When lifting anchors 6 are located in the horizontal top faces of concrete panels 11, which are then tilted up into the vertical or near vertical position, the direction of load changes with respect to the anchor 6, the torus 4 and the latch 14. It is evident that the link 1 could be connected such that the radial lever arm 15 is oriented to ensure that during lifting it lies between the concrete face 10 and the shackle 2 whereby, if it is sufficiently long, it is prevented from rotation by the bridge 13 (FIG. 2C) of the shackle 2 (in the manner disclosed in FIG. 4 of the abovementioned PCT WO 82/01541), thereby preventing disconnection of the link 1 from the anchor 6.

As seen in FIGS. 2G to 2I, when the prior art link is connected in the opposite orientation (to that which is disclosed in FIG. 4 of the abovementioned PCT specification), or if the radial arm 15 is not of sufficient length to be restrained by the bridge 13 of the shackle 2, then disconnection is possible if the forces induced or applied to the latch 14 during the lifting operations are sufficient to cause it to rotate and disconnect from the anchoring device 6.

As seen in FIGS. 2F to 2I, when a concrete element10 e.g. a concrete panel is rotated up from the horizontal to the vertical position using anchors placed in the face of the panel, the centre of gravity 19 rotates about the centre 18 of the latch 14.

FIG. 2F shows a prior art link connected to an anchor 6 embedded in the top horizontal surface 10 of a concrete panel 11. Initially, when load is applied to the anchor through the link, the centre of gravity 19 of the latch 14 lies to the right of, and below, the centre of lift which is vertically aligned with the axis of the lifting anchor 6 and the rotational axis 20 of the toroidal body 4 and the rotational axis 18 of the latch which are co-incident. The eccentricity between the centre of the load aligned to the centre of rotation 18,20 and the centre of gravity 19 of the latch 14 generates a clockwise rotational force imparted to the latch 14, causing the latch 14 to bear against the anchor 6, maintaining it in its fully closed (safe) position.

FIG. 2G shows a prior art link connected to an anchor 6 embedded in the vertical face of a concrete panel in its equilibrium position where the centre of gravity 19B of the latch is aligned vertically with the centres of rotation 18, 20 of the latch 14 and toroidal body 4 of the link 1. It can be seen that the alignment of the centre of gravity 19B with the centre of rotation 18, 20 of the latch 14 and toroidal body 4 of the link 1 corresponds to an anticlockwise partial rotation of the latch 14 with respect to the body 4 and anchor 6 to an equilibrium latch position represented by 14B. It is evident that when the latch 14 is in the position 14B it is not fully closed with respect to the body 4 and the anchor 6. Thus, the latch 14 is potentially unsafe.

FIG. 2H shows a panel in the vertical position after tilting up from the horizontal position of FIG. 2F. Provided that the lifting load is maintained, frictional forces generated between the latch 14 and the anchor 6 maintain the latch 14 in the meta-stable (closed) position represented by 14A where the centre of gravity 19A of the latch 14 lies to the left of the stable equilibrium position represented by 19B as seen in FIG. 2G. When the load is relaxed, the latch 14 auto-rotates anti-clockwise towards the stable position with centre of gravity 19B aligned with the centre of rotation 18,20 of the latch 14.

FIG. 2I demonstrates the situation commonly found in practice when the load is relaxed after tilting a panel from the horizontal to the vertical position, and particularly when manoeuvring panels in the air between various attitudes. Dynamic rotational inertia is generated in the latch 14 as it moves to align its centre of gravity from the state represented by 14A with its centre of gravity at 19A to adopt its equilibrium centre of gravity represented by 19B. Sudden relaxation of the load causes the latch to swing rapidly past its equilibrium position represented by 14B and towards its unlatched position indicated at 14C. In practice, it is known that the latch 14 can disconnect from the anchor 6 in this fashion.

In addition to the gravitational forces acting upon the centre of gravity of the latch 14, other rotational inertial forces may be imparted to the latch 14 as the panel rotates from one state to another whilst suspended on the lifting link 1. Load relaxations can, and do, occur in practice. In particular, alterations in the panel attitude during complex lifting and rotational movements whilst panels are suspended, generate complex, dynamically changing load vectors.

It is common practice to tilt panels from the horizontal using anchors embedded in one edge and then to rotate the panel to the vertical position whilst suspended by the crane, in an edgewise manner by progressively loading anchors embedded in an edge normal to the anchors by which the panels are initially lifted and tilted. FIGS. 2J-21 show this procedure using prior art lifting links connected in a safe but inconvenient configuration. FIGS. 2M-20 show the same procedure with the prior art lifting links connected in a convenient but unsafe configuration.

Such rotations may result in momentary release of load between the anchors 6 and lifting links 1 combined with dynamically induced rotational loads.

Additionally, it is normal practice to attach latch release lines (not shown) to the radial lever arm 15 which extend up and over the crane hook (not shown). The release lines enable the remote release of the latch 14 from the lifting insert 6. As can be expected, the release lines can become fouled and caught in the surrounding equipment during the lifting and rotating process causing the latch to rotate and disconnect during rotation.

Mid-air, unexpected disconnections, either as a result of momentary release of the load, or as a result of snagging the remote release lines, have caused serious accidents.

FIGS. 2J-2L show a concrete element 11 being lifted and rotated from the horizontal position to the vertical position in a direction shown by arrow RP, by two prior art lifting links 1 connected to the crane rigging 25 (not detailed) by running rigging comprising a wire rope 26 passing over a sheave 27.

FIG. 2J shows that both links are attached in a safe, locked configuration with the radial arm 15 of the latch 14 in the vertical-up position and locked between the concrete surface 10 and shackle 2.

FIG. 2K and FIG. 2L show, however, the difficulty of releasing these lifting links. It is possible to release the links 1 manually, however, this is often inconvenient for tall elements where it is desired to release these remotely using a remote release line attached to the arm 15 of the latch 14. In FIG. 2L the arm 15 of the left-hand link 1 may be rotated toward the crane rigging 25 to disconnect the link. However, the right-hand link presents a problem because when the load is relaxed, causing the line 26 to relax, the shackle 2 falls toward the hook 25. This locks the radial arm 15 behind the shackle 2. The hook 25 must be traversed to the right to release the arm 15 to enable disconnection. This is not easily achieved because the mass of the disconnected rigging elements causes free rotation of the rope 26 around the sheave 27.

Because of these difficulties, operators are tempted to (and commonly do) choose to connect the lifting links 1 in the convenient but unsafe configuration shown in FIGS. 2M-20. These Figs. show the same element rotation but with the lower link shown in FIG., 2M connected with the lever arm 15 pointed vertically down. This is an unsafe configuration for the reasons discussed previously in reference to FIGS. 2G-2I.

As shown in FIG. 2N, after rotation of the concrete element 11, both arms 15 of the latches 14 of the links 1 point away from the crane rigging 25 which enables the links 1 to be easily and conveniently disconnected, either manually or remotely, using remote release lines.

FIG. 20 shows the links 1 disconnected and free to be removed by lifting the crane rigging 25, 26 away from the element 10.

Attempts to minimise the distance between the rotational centre 18 and the centre of gravity of the latch 19 by fitting a long radial lever arm 15 can be counter-productive as this increases the rotational inertia. This amplifies the tendency for the latch 14 to disconnect from anchor 6 during tilting and rotational operations whilst suspended.

The Inventor has determined that it would be desirable to have a latch 14 which has a centre of gravity 19 more closely aligned with its centre of rotation 18 when located in the vertical surface or edge as shown in FIG. 1C. This is to preclude the movement of latch 14 as a result of gravitational misalignment in its equilibrium position. It is also desirable to have a means of locking the latch 14 to prevent its disconnection during lifting and manoeuvring as a result of induced dynamic or other externally applied forces.

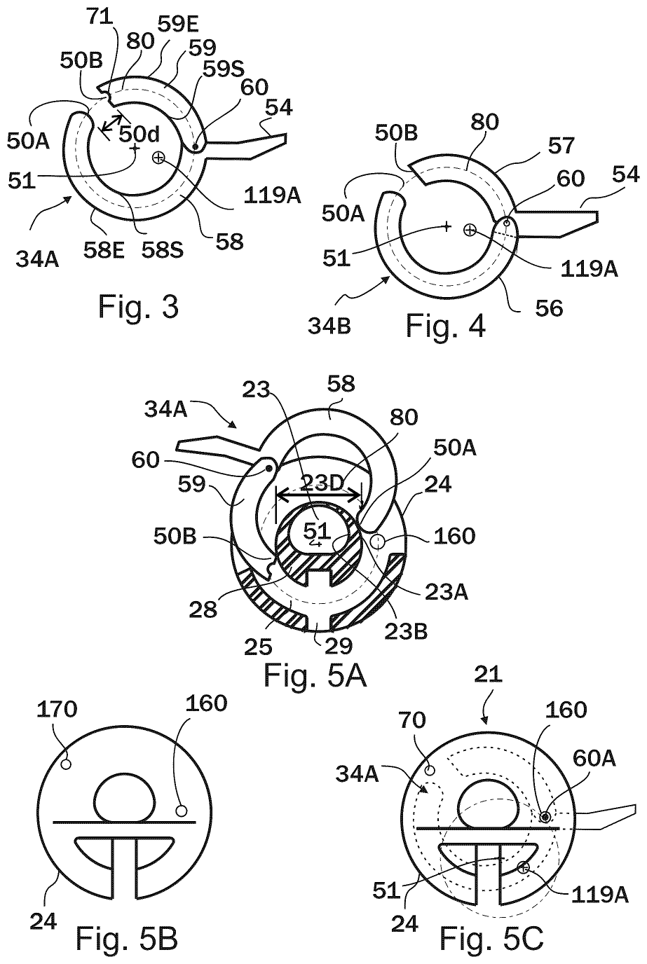

FIG. 3 shows a latch 34A of a preferred embodiment of the present invention which is comprised of two separable arcuate parts, a latch part 58 and an upper part 59. These are joined by, and are rotatable about a hinge 60, with an axle 60A. The axle 60A has an axis which is orthogonal to the arcuate locus 80 of the arcuate latch part 58. The hinge 60 permits the two parts 58 and 59 of the latch 34A to be pivoted relative to each other. Rotation of the two parts 58 and 59 relative to each other changes the spatial relationship between the centre of gravity 119A of the latch 34A and the centre of rotation 51 of the latch 34A.

Latch part 58 has an internal surface 58S, an external surface 58E and a nose 50A. Upper part 59 has an internal surface 59S, an external surface 59E and a nose 50B.

The double-ended dimension arrow indicates the distance between noses 50A and 50B when the arcuate central loci 80 of both parts 58,59 are congruent and share the same centre of rotation 51.

The nose 50B of the upper part 59 of latch 34A may, if desired, be shaped with an abutment location surface 71 (FIG. 3) at its tip and shaped as a concave transverse groove facing outwardly.

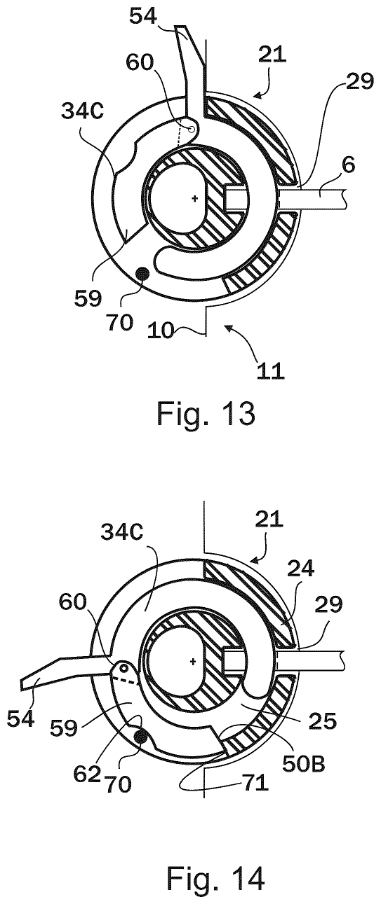

The distal end of the radial arm 54 is angled away from the surface 10 of the panel 11 which has the effect of moving the centre of gravity of the latch 34C in the same direction. Further, this kink provides a clearance between the concrete surface 10 and the radial arm 54 which facilitates grasping of the arm 54 when the radial arm 54 has been rotated in a direction away from the shackle 2 to its closed position (illustrated in FIG. 13), resting against the concrete surface 10.

It is also apparent from FIG. 3 that the internal circular extent of the latch 34A is very much greater than 180° and approaches 360°. The preferred circular extent of the latch 34A is approximately 250°. Rather than modify the toroidal body 24, it is desirable to make the latch 34A in two pieces which are pivotable relative to each other so as to permit the latch 34A to be located within the toroidal body 4 as shown in FIG. 5A.

FIG. 4 shows a latch 34B of another embodiment having two separable parts 56 and 57 joined by, and pivotable about, a hinge 60. The hinge 60 has an axle 60A, whose axis is orthogonal to the arcuate locus 80 of the arcuate latch part 56. The hinge 60 permits the latch 34B to be opened and closed about the internal arcuate surface 23A of diameter 23D of a toroidal body 24, as required for insertion and removal therefrom.

FIGS. 5A-5C show a toroidal body 24 with a central transverse aperture 23, an interior wall 23B and an interior arcuate surface 23A with a diameter 23D indicated by a double-ended dimensional arrow. The toroidal body has a transverse aperture 160 in at least one of the side walls of the upper part of the body 24, located to permit the insertion of the hinge axle 60A of the latch 34A and a further transverse aperture 170 in the side walls to permit insertion of a stop pin 70 (FIG. 5C) after the latch 34A has been inserted into the body 24. The stop pin 70 restricts rotation of the latch 34A to prevent its removal from the toroidal body after its insertion.

As seen in FIG. 5A, the latch 34A is inserted into the toroidal body 24 by rotating the upper arcuate part 59 in a clockwise direction relative to the lower part 58, sufficient to open up a gap between the noses 50A and 50B which exceeds the diameter 23D of the interior arcuate surface 23A of the body 24. The optimum embodiment of latch 34A is one in which the location of its centre of gravity 119A lies as close as possible to its centre of rotation 51 which is achieved by minimising the gap 50d between the noses 5A and 50B to a distance just greater than the width of the transverse slot 29 of the toroidal body 24. In order to install such an optimum latch 34A the two parts 58 and 59 of the latch 34A may be separated and then installed into the body 24 by first inserting the latching part 58 into the toroidal body 24, followed by the upper part 59 and finally joining the two parts 58 and 59 at the hinge 60 by inserting the hinge axle 60A through a hole 160 of the toroidal body 24.

As seen in FIG. 5C, after insertion of the latch 34A and closure about the interior arcuate surface 23A of the toroidal body 24, the surfaces 58S and 59S of the latch parts 58 and 59 lie substantially adjacent to the bearing surface 23A of the toroidal body 24 such that the surfaces 58S and 58E lie equidistant from the locus 80 with centre 51 of the toroidal body 24.

The distance 50d between the noses 50A and 50B is now less than the diameter 23D of the bearing surface 23A and the stop pin 70 prevents removal of the latch 34A from the toroidal body 24.

The latch 34A in this “closed” (locked) position has a centre of gravity 119A displaced from the centre of rotation 51 of the latch 34A and the toroidal body 24. This is similar to the prior art latch 14 and the spatial relationship between the centre of gravity 19 and centre of rotation 18 is similar. The locus of rotation 80 of both noses 50A and 50B follows a circular path about the centre of rotation 51 of the latch 34A.

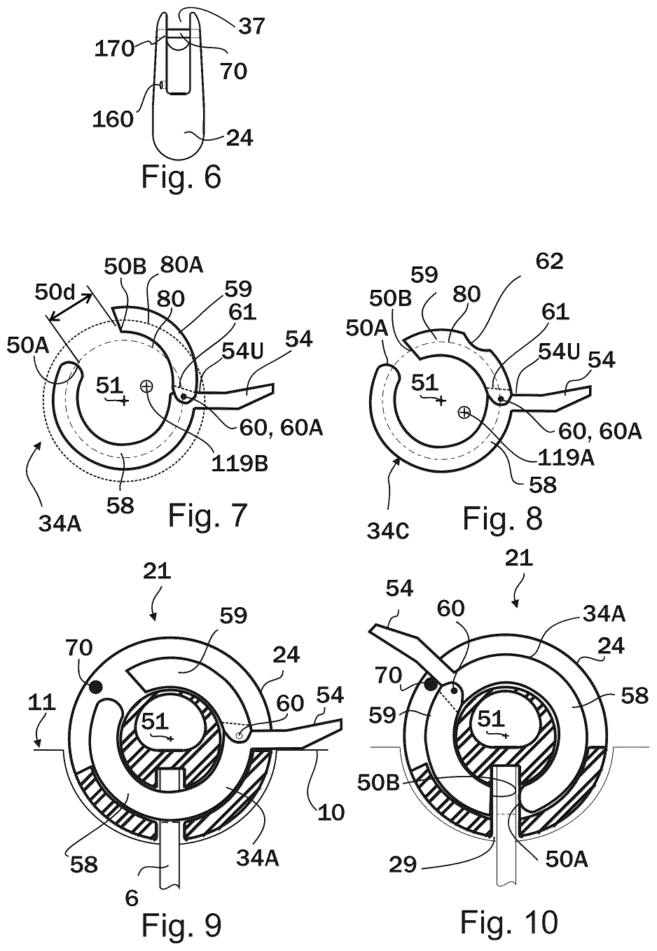

FIG. 6 shows a rear elevation of the toroidal body 24 with the stop pin 70 installed in the transverse aperture 170.

FIG. 7 shows the preferred embodiment of the latch 34A with the upper arcuate part 59 rotated about the hinge 60 to an open position. Latch 34A incorporates an interior abutment surface 61 within part 59 which contacts the upper surface 54U of the radial arm 54 to effectively limit the rotation of part 59 about the hinge 60 and thereby limit the fully open position of part 59 with respect to the arcuate latch part 58.

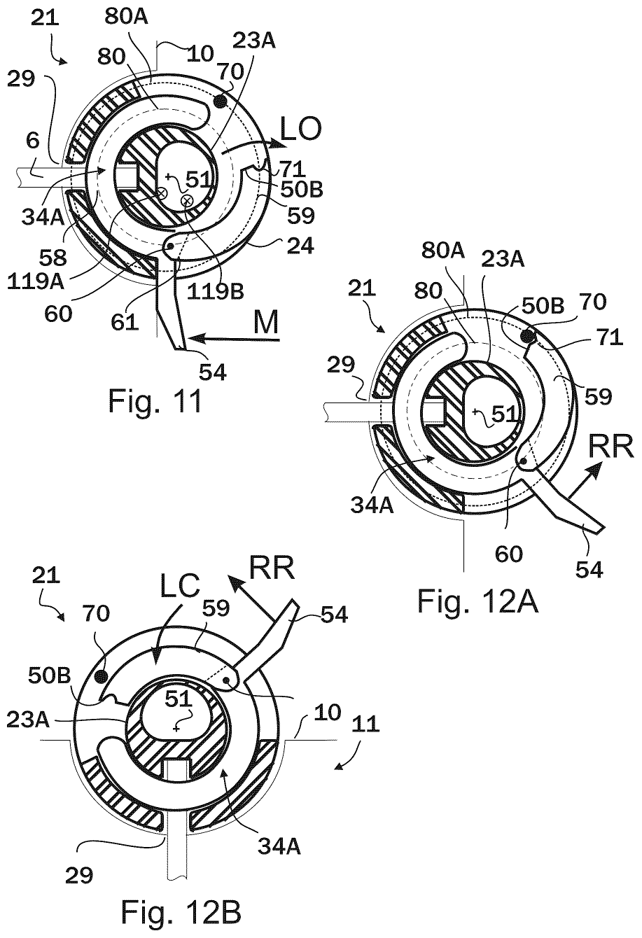

It can be seen that when the latch part 59 is rotated about the hinge 60 to its fully open position and restricted by the abutment surfaces 61 and 54U, rotation of the latch 34A about the centre 51 changes the locus of rotation of the nose 50B from the locus 80 to a locus 80A(FIG. 11) of larger diameter, thereby displacing the nose 50B of the latch 34A radially away from the centre 51. This rotation also causes the centre of gravity 119B of the latch 34A to move radially outward from its initial position 119A of the latch 34A shown previously in FIG. 3 and FIG. 5C.

FIG. 8 shows yet another embodiment in latch 34C which is substantially identical to latch 34A, and shown in the closed position, but has a portion 62 of the upper hinged part 59 cut away so as to provide additional outward radial movement of the part 59. The portion 62 is a concave cavity which faces radially outwardly.

The two co-operating parts 58 and 59 of the latch 34A provide a means of articulation, permitting linked but separate movements during panel lifting and rotation, thus dynamically moving the centre of gravity 119A of the latch 34A toward a more favourable equilibrium position 119B (FIGS. 7 and 11) in the various orientations of the link 21 with respect to the concrete surface 10. The hinging action also provides an additional means to enable the positive locking of the latch 34A to restrict its rotation to prevent the release of the anchor 6 from the latch 34A in any orientation of the link 21.

As seen in FIGS. 9 and 10, when the link 21 is connected to an anchor 6 embedded in the horizontal surface 10 of a panel 11, the link 21 operates in a similar way to the prior art link 1. Link 21 has an arcuate latch 34A of centre 51 located so that the arcuate locus 80 of latch 34A is centrally located in cavity 25 (FIG. 5A) of toroidal body 24.

FIG. 9 shows the latch 34A rotated clockwise about its axis 51 to the closed (locked) position where the radial arm 54 meets the toroidal body 24, substantially in the plane of the horizontal surface 10 of the panel 11. As seen in FIG. 10, the latch 34A may be opened by rotating the radial arm 54 anti-clockwise until its upper surface rests against the stop pin 70, at which position the nose 50A of part 58 and nose 5B of part 59 of the latch 34A do not obstruct the transverse slot 29.

FIG. 11 shows the link 21 connected to an anchor 6 embedded in the vertical surface 10 of a panel 11 with the radial arm 54 of the latch 34A directed vertically down with respect to the transverse slot 29. The hinge 60 permits gravity to cause part 59 of the latch 34A to fall outwardly, rotating about hinge 60 and away from the centre of rotation 51 in a direction indicated by arrow LO. This causes the centre of gravity 119B of latch 34A to move from its original position 119A to a new position 119B to the right and below the centre of rotation 51. The force of gravity acting upon the new position of the centre of gravity 119B results in a turning moment of the latch 34A relative to the toroidal body 24 in a direction indicated by arrow M in FIG. 11. This causes the latch to move toward the “closed position” with the lever arm 54 lying adjacent the concrete surface 10. This restrains the latch 34A from rotating anti-clockwise toward the unlatched position if the load is relaxed. To maximise safety, the rotation of part 59 about hinge 60 is desirably limited to ensure that the nose 50B of the part 59 remains enclosed within the toroidal body 24. The enclosure of part 59 within the envelope of the toroidal body 24 ensures that the part 59 cannot be snagged on any exterior object or obstruct the movement of the shackle 2 (not illustrated in FIG. 11) about the link 21.

In order to prevent part 59 moving beyond the envelope of the toroidal body 24, the maximum distance 50d shown in FIG. 7 is restricted. Thus, the relative rotation between parts 58 and 59 is limited by contact between the radial arm 54 and the abutment surface 61 to prevent part 59 moving beyond the outside diameter of the toroidal body 24.

It can be understood that the positive turning moment M of the latch 34 toward the “closed” position also resists dynamic inertial effects imparted to the latch 34A resulting from accelerations imparted to the link 21 during the lifting and tilting operations. This is particularly the case if the link becomes unloaded (e.g. in a load reversal from a slack-rope condition) and frictional resistance is lost between the anchor 6 and part 58 of the latch 34A.

Additionally, the radial arm or handle 54 could be unintentionally rotated anti-clockwise toward the “open” disconnected position by an external force in a direction shown by arrow RR, e.g. by the action of a remote release line RR attached to the arm 54. Then, as seen in FIG. 12A, rotation of the latch 34A toward the disconnected condition, is prevented by contact between the nose 50B of the articulated part 59 and the stop pin 70 which provides an abutment surface. This effectively locks the rotation of the latch 34A.

The shaping of the nose 50B with the location groove 71 of the latch 34A prevents the nose 50B of the latch 34A sliding past the pin 70 as a result of the radial outward moment generated by the eccentricity between the hinge 60 located on locus 80 and the nose 50B on locus 80A.

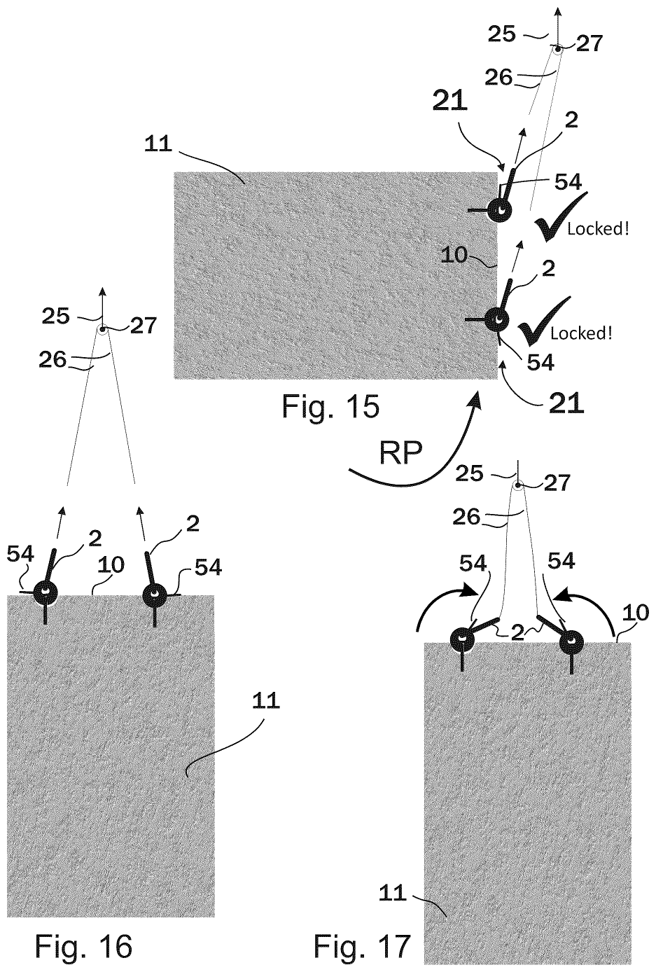

FIG. 12B shows the effect of anti-clockwise rotation of the concrete element 11 (in the manner shown in FIG. 15 and FIG. 16 and described below), with the link 21 attached to the edge in the vertical direction (FIG. 11) to a horizontal position (FIG. 12B). Gravity causes the part 59 of the latch 34A to fall, rotating about the hinge 60 anti-clockwise in a direction indicated by the arrow LC until the internal surface 59S of the latch 34A rests against the internal surface 23A of the toroidal body 24. This permits the external surface 59E and nose 50B of the part 59 of the latch 34C to pass between the stop pin 70 and the surface 23A. This in turn enables the latch 34A to be freely rotated by its lever arm 54 in a direction shown by the arrow RR to its open position allowing disengagement from the anchor 6. This external force may be conveniently effected with a remote-release rope RR attached to the lever arm 54.

It will be realised by those skilled in the art that this arrangement provides a significant improvement in safety compared to using links 1 when edgewise lifting and rotating concrete elements 11. This is of particular importance for the construction of high-rise buildings, where large panels, typically weighing 10-20 tonnes are hoisted and rotated in mid-air above busy city streets. The locking action occurs both automatically and autogenously. The arrangement provides the most effective method for minimising risk, by substitution with a simple, fail-safe engineered method for risk control. A significant benefit is that the safety of existing links 1 can be improved by the simple substitution of the latch 14 with the latch 34A of the preferred embodiment.

Importantly this arrangement does not rely on any complex mechanical locking devices being attached to the link 21 or the latch 34. These can be damaged and fail when needed. The arrangement precludes the need for special supervision or actuation by an operator. The latch 34 is safely locked to the anchor 6 during all phases of lifting and turning. The movement of the latch 34A and its locking and unlocking functions are determined only by geometric features of the link 21 and the latch 34A working in conjunction with the force of gravity and the turning motion of the element 11. That is to say, the arrangement provides the safety required when rotating panels, by autogenous action brought about by the panel rotation. In all situations where panel rotation is not required, the arrangement functions in substantially the same way as prior-art links 1 and their latches 14.

FIG. 13 shows the link 21 connected to an anchor 6 embedded in the vertical surface 10 of a panel 11 with the radial lever arm 54 of the latch 34E directed vertically up with respect to the transverse slot 29. Rotation of the latch 34E under gravity results in anti-clockwise rotation of the latch 34E which is normally limited by the latch part 59 abutting the stop pin 70. Thus, the link remains locked.

If vibration, or an external force, for example, causes rotation to continue as illustrated in FIG. 14, the cut-away section 62 allows gravity to cause the hinged part 59 to pivot vertically downwards, forcing the nose 50B to contact an abutment surface 71 of the toroidal body 24. This prevents entry of the part 59 of the latch 34E into the interior arcuate cavity 25 of the toroidal body 24, effectively locking the latch 34E, thereby preventing both further rotation and disconnection.

FIGS. 15-17 show a concrete element 10 being lifted and rotated from the horizontal position to the vertical position in a direction shown by arrow RP (similar to FIGS. 2M-20), by two lifting links 21 with latches 34A of a preferred embodiment. These are connected to the crane rigging 25 (not detailed) by running rigging comprising a wire rope 26 passing over a sheave 27.

FIG. 15 shows that both links 21 are attached in a safe, locked configuration. The first, upper link 21 is attached with the radial arm 54 of the latch 34A in the vertical-up position and locked between the concrete 10 and shackle 2. The second and lower link is attached with the radial arm 54 pointing down but rotation of the latch 34A is restricted and locked by stop pin 70 as described above and shown in FIGS., 11 and 12A.

FIGS. 16 and 17 show that the concrete element of FIG. 15 rotated into the vertical position. It will be appreciated that the articulated part 59 of the latch 34A will drop back down to a position adjacent to the arcuate surface 23A of the toroidal body 24 when the link 2 is in the position shown in FIG. 16. This allows the free rotation of the latch 34A as described previously and shown in FIG. 12B.

It can be seen that in this position both of the radial arms 54 are positioned pointing away from the crane rigging 25 making manual or remote disconnection by a remote release line attached to the radial arm 54 of the latch 34A simple, safe and conveniently easy.

This link embodiment therefore satisfies the requirements for safety, ease and convenience of use.

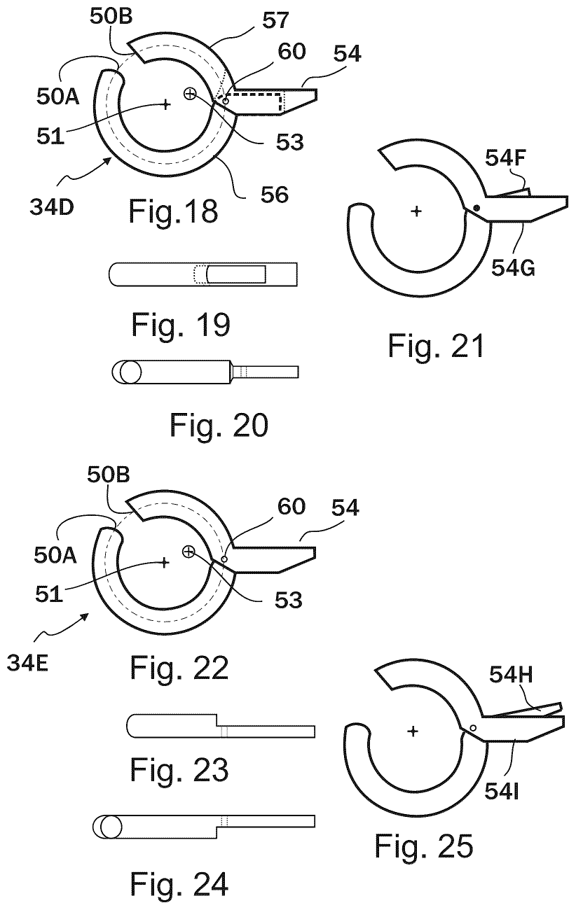

A further, and modified, embodiment 34D of the several hinged latch rings illustrated in FIGS. 3-14, is illustrated in FIGS. 18-21. The larger part 56 of the latch ring 34D includes a lever arm extension 54F whilst the smaller part 57 also includes a lever arm extension 54G. The two parts 56, 57 are pivoted by means of a pivot 60 and function in the manner of a pair of scissors. It will be seen that the lever arm extension 54F fits snugly within the lever arm extension 54G so that they operate as one when the latch ring 34D is located within the hollow body 24.

Another embodiment 34E of the latch ring is illustrated in FIGS. 22-25. The two parts 56 and 57 are pivoted at 60 as before but the lever arm extensions 54H and 54I mate in side-by-side arrangement to ensure that they operate as one when the scissors latch ring 34E is located within the hollow body 24.

The foregoing describes only some embodiments of the present invention and modifications, obvious to those skilled in the panel lifting art, can be made thereto without departing from the scope of the present invention. For example, the features and advantages disclosed to one facet of the invention may be utilised, mutatis mutandis, in other facets of the invention.

The term “comprising” (and its grammatical variations) as used herein is used in the inclusive sense of “including” or “having” and not in the exclusive sense of “consisting only of”.

1. A releasable lifting link for lifting concrete elements having an embedded anchor with a through aperture in the anchor's head, said lifting link comprising a hollow toroidal body with an interior arcuate surface and a through aperture for engagement with a lifting shackle and a transverse slot for receiving the head of the anchor, and an arcuate latch having a centre of gravity and being rotatably mounted within the toroidal body about a toroid centre of rotation, said latch having a handle which projects beyond the body, and said latch being rotatable between an open position in which a free end of said latch is retracted to open said transverse slot and a latching position in which said latch free end extends through and beyond said aperture, wherein said latch is fabricated in two or more parts which are pivoted relative to each other.

2. The releasable lifting link as claimed in claim 1 wherein said latch comprises a first arcuate arm including said handle, and a second arcuate arm pivoted to said first arcuate arm and extending from said handle towards said latch free end, said latch forming part of an incomplete circle rotatable within said toroidal body.

3. The releasable lifting link as claimed in claim 2 wherein said second arm has a free end and is pivotable into a configuration in which the free end is spaced from said latch free end by a minimum distance less than the internal diameter of the said latch and just exceeding the width of said transverse slot.

4. The releasable lifting link as claimed in claim 2 wherein said second arm has a free end and is pivotable into a configuration in which the free end is spaced from said latch free end and that spacing is restricted such that said free end does not project beyond an outside diameter of said toroidal body.

5. The releasable lifting link as claimed in claim 3 wherein said second arm free end is engageable with a stop pin extending across said hollow toroidal body to limit the rotation of said latch.

6. The releasable lifting link as claimed in claim 1 wherein said second arcuate arm pivot is located adjacent said latch handle.

7. The releasable lifting link as claimed in claim 6 wherein said second arcuate arm includes a concave cavity facing radially outwardly.

8. The releasable lifting link as claimed in claim 1 wherein said second arcuate arm has a second handle which projects beyond the toroidal body.

9. The releasable lifting link as claimed in claim 8 wherein said handle and said second handle are mounted as the handles of a pair of scissors.

10. The releasable lifting link as claimed in claim 8 wherein said second handle is receivable within said handle.

11. A releasable lifting link for lifting concrete elements having an embedded anchor with a through aperture in the anchor's head, said lifting link comprising a hollow toroidal body with an interior arcuate surface and a through aperture for engagement with a lifting shackle and a transverse slot for receiving the head of the anchor, and an arcuate latch with a centre of gravity and having a first free end and a second end which terminate the circumferential arcuate length of said latch, said arcuate latch being rotatably mounted within the toroidal body about a toroid centre of rotation, said latch having a handle which projects beyond the body, and said latch being rotatable between an open position in which the said first free end of said latch is retracted to open said transverse slot and a latching position in which said latch free end extends through and beyond said aperture, wherein the distance between the first free end and the second end is less than a diameter of said interior surface of said toroidal body.

12. The releasable lifting link as claimed in claim 11 wherein the circumferential extent of said arcuate latch approaches, but is less than, 360°.

13. The releasable lifting link as claimed in claim 12 wherein the circumferential extent of said arcuate latch is approximately 250°.

14. The releasable lifting link as claimed in claim 1 wherein said arcuate latch is provided with a second arcuate arm extending from said handle towards said latch free end, said latch forming part of an incomplete circle rotatable within said toroidal body.

15. In a releasable lifting link for lifting concrete elements having an embedded anchor with a through aperture in the anchor's head, said lifting link comprising a hollow toroidal body with an interior arcuate surface and a through aperture for engagement with a lifting shackle and a transverse slot for receiving the head of the anchor, and an arcuate latch having a centre of gravity and being rotatably mounted within the toroidal body about a toroid centre of rotation, said latch having a handle which projects beyond the body, and said latch being rotatable between an open position in which a free end of said latch is retracted to open said transverse slot and a latching position in which said latch free end extends through and beyond said aperture, the improvement comprising modifying said latch such that with said lifting link in a lifting position, the centre of gravity of said latch is closer to said toroid centre of rotation.

16. The improvement as claimed in claim 15 wherein said latch comprises at least two separate parts.

17. The improvement as claimed in claim 16 wherein said latch comprises a first arcuate part and a second arcuate part which is pivoted relative to said first arcuate part.

18. The releasable lifting link as claimed in claim 17 wherein said first and second arcuate parts each have a free end and are pivotable into a configuration in which the free ends are spaced apart from each other by a minimum distance less than an internal diameter of said latch and just exceeding the width of said transverse slot.

19. The releasable lifting link as claimed in claim 17 wherein said first and second arcuate parts each have a free end and are pivotable into a configuration in which the free ends are spaced apart from each other by a distance which is restricted such that the free end does not project beyond an outside diameter of said toroidal body.

20. The improvement as claimed in claim 17 wherein the arcuate extent of said latch approaches, but does not exceed, 360°.

21. The improvement as claimed in claim 17 wherein the arcuate extent of said latch is approximately 250°

22. The improvement as claimed in claim 15 wherein said handle is kinked towards the centre of rotation of said latch.

23. A method of lifting a concrete element having an embedded anchor with a through aperture in the anchor's head, using a releasable lifting link comprising a hollow toroidal body with an interior arcuate surface and a through aperture for engagement with a lifting shackle and a transverse slot for receiving the head of the anchor, and an arcuate latch having a centre of gravity, and a first free end and a second end which terminate the circumferential arcuate length of said latch, said arcuate latch being rotatably mounted within the toroidal body about a toroid centre of rotation, said latch having a handle which projects beyond the body, and said latch being rotatable between an open position in which the said first free end of said latch is retracted to open said transverse slot and a latching position in which said latch free end extends through and beyond said aperture, wherein said method comprises the step(s) of
(i) making the distance between the first free end and the second end less than a diameter of said interior surface of said toroidal body, and/or
(ii) fabricating said latch in two or more parts which are pivotable relative to each other, and/or
(iii) modifying said latch such that with said lifting link in a lifting position, the centre of gravity of said latch is closer to said toroid centre of rotation.

24. The method as claimed in claim 23 including the further step of forming said latch to have a first arcuate arm including said handle, and a second arcuate arm pivoted to said first arcuate arm and extending from said handle towards said latch free end, said latch forming part of an incomplete circle rotatable within said toroidal body.

25. The method as claimed in claim 24 wherein said second arm has a free end and is pivotable into a configuration in which the free end is spaced from said latch free end by a minimum distance less than an internal diameter of said latch and just exceeding the width of said transverse slot.

26. The method as claimed in claim 24 wherein said second arm has a free end and is pivotable into a configuration in which the free end is spaced from said latch free end by a distance which is restricted such that the free end does not project beyond an outside diameter of said toroidal body.

27. The method as claimed in claim 25 wherein said second arm free end is engageable with a stop pin extending across said hollow toroidal body to limit the rotation of said latch.

28. The method as claimed in claim 24 wherein said second arcuate arm pivot is located adjacent said latch handle.

29. The method as claimed in claim 28 wherein said second arcuate arm includes a concave cavity facing radially outwardly.

30. The method as claimed in claim 24 wherein said second arcuate arm has a second handle which projects beyond the toroidal body.

31. The method as claimed in claim 30 including the step of mounting said handle and said second handle as the handles of a pair of scissors.

32. The method as claimed in claim 31 including the step of mounting said second handle to be receivable within said handle.

33. The method as claimed in claim 24 wherein the circumferential extent of said arcuate latch approaches, but is less than, 360°.

34. The method as claimed in claim 33 wherein the circumferential extent of said arcuate latch is approximately 250°.
